(19) United States
(12) Patent Application Publication
(10) Pub. No.: US 2014/0051433 A1
(43) Pub. Date: Feb. 20, 2014

(54) METHOD AND AN APPARATUS FOR REDUCING ENERGY CONSUMPTION IN A BASE STATION OF A CORRDLESS TELEPHONE

(71) Applicant: Otmar Rengert, Nuremberg (DE)

(72) Inventor: Otmar Rengert, Nuremberg (DE)

(21) Appl. No.: 13/985,292

(22) PCT Filed: Mar. 7, 2011
(86) PCT No.: PCT/IL2011/000216

§ 371 Date: Oct. 24, 2013

(51) Int. Cl. H04W 52/02

(52) U.S. Cl. CPC H04W 52/0209
USPC 455/426.1

(57) ABSTRACT

A method and apparatus for reducing power consumption in a base station of a cordless handset supporting a subset of a plurality of carrier frequencies supported by the base station, the method comprising disconnecting power to a receiver of the base station for carrier frequencies that are not supported by the cordless handset, thereby reducing power consumption by the base station.

### BACKGROUND

The present disclosure relates to cordless telephones in general, and to operation of a base station of the cordless telephone, in particular.

A cordless telephone or portable telephone is a wireless handset that may communicate via radio with a base station that is connected to a network such as PSTN.

A single base station may communicate with one or more handsets, allowing several cordless telephones to be placed and operate around a residence.

The communication between the base station and the handset may be performed via Digital Enhanced Cordless Telecommunications (DECT) protocol, such as CAT IQ protocol. In a DECT or similar cordless telephony the communications is carried out with a plurality of frequencies or carriers (FDMA) operating by a time division or slots regime (TDMA). The protocol provides a synchronization process between the base station and the handset, such as selecting a carrier frequency with which the handset and the telephone may communicate.

The handset station may have a list of carrier frequencies available to use by the handset. The base station may have a list of carrier frequencies available for use by the base station. The base station list of carrier frequencies may comprise at least all the available frequencies of the handset, where, in some cases, the base station list of available carrier frequencies may comprise carrier frequencies that are not included, that is, not supported, in the handset list of available carrier frequencies.

The base station and the handset may synchronize at idle time, when there is no call, such as for establishing a carrier for a new call upon demand. The base station and the handset may also synchronize during the call for changing the carrier frequency when required, such as due to interference in the carrier used.

Upon synchronization, the handset may choose a carrier frequency from the handset list and may try to communicate with the base station by sending a setup message through the chosen carrier frequency. The base station may periodically tune the carrier frequency of the base station receiver in order to match the receiver carrier frequency with the carrier frequency that is chosen by the handset. Periodically tuning the receiver carrier frequency may be done by choosing a next carrier frequency from the base station list of available carrier frequencies and by tuning the receiver of the base station to the chosen carrier frequency for a predefined period. When a match between the base station carrier frequency and the handset carrier frequency is found, the base station reply the handset setup request through the currently chosen frequency and the setup process may start. Upon completion of the setup process, the base station and the handset may communicate via the chosen carrier frequency.

### BRIEF SUMMARY

According to exemplary embodiments of the present disclosure there is provided a method for reducing power consumption in a base station of a cordless handset supporting a subset of a plurality of carrier frequencies supported by the base station, the method comprising disconnecting power to a receiver of the base station for carrier frequencies that are not supported by the cordless handset, thereby reducing power consumption by the base station.

According to some embodiments, disconnecting power is for a predefined time, optionally the predefined time is sufficient for allowing subsequent listening by the base station to the cordless handset through a carrier frequency supported by the cordless handset.

In some embodiments, disconnecting power to a receiver of the base station for carrier frequencies that are not supported by the cordless handset comprises informing the cordless handset that the base station uses carrier frequencies which the cordless handset can support in addition to carrier frequencies that the cordless handset can not support, and turning off the wireless communications thereby allowing the cordless handset to assume that the carrier frequencies that are not supported by the cordless handset are in use by the base station.

In some embodiments, disconnecting power to a receiver of the base station for carrier frequencies that are not supported by the cordless handset comprises setting parts of the base station to lower power, thereby further reducing the power consumption of the base station.

According to exemplary embodiments of the present disclosure there is provided an apparatus for reducing energy consumption in a base station of a cordless telephone, the apparatus comprising a base station supporting a plurality of carrier frequencies and having a receiver configured to receive a transmission from the cordless handset supporting a subset of the plurality of carrier frequencies, and further configured for turning off power to the receiver for carrier frequencies that are not supported by the cordless handset.

In some embodiments, turning off power to the receiver comprises turning off the wireless communication of the base station.

In some embodiments, turning off power to the receiver for carrier frequencies that are not supported by the cordless handset comprises informing the cordless handset that the base station uses carrier frequencies which the cordless handset can support in addition to carrier frequencies that the cordless handset can not support, and turning off the wireless communications thereby allowing the cordless handset to assume that the carrier frequencies that are not supported by the cordless handset are in use by the base station. Optionally, turning off power to the receiver for carrier frequencies that are not supported by the cordless handset comprises setting parts of the base station to lower power, thereby further reducing the power consumption of the base station.

### THE BRIEF DESCRIPTION OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a schematic drawing of an environment comprising a base station and a handset;

FIG. 2 shows a block diagram of a base station configured for reducing energy consumption in a base station of a cordless telephone, in accordance with some exemplary embodiments of the disclosed subject matter;

FIG. 3 shows a flowchart diagram of a method for synchronizing between a telephone and a handset while reducing energy consumption in a base station, in accordance with some exemplary embodiments of the disclosed subject matter; and

FIG. 4 shows an exemplary diagram of an exemplary time axis during which the chosen carrier frequency is changed.

### DETAILED DESCRIPTION

The disclosed subject matter is described below with reference to flowchart illustrations and/or block diagrams of methods, apparatus (systems) and computer program products according to embodiments of the subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

One technical problem dealt with by the disclosed subject matter is to reduce power consumption in a base station of a cordless telephone while keeping the standards of communication between the handset and the base station. Such a standard of communication may be, for example, DECT standard.

One technical solution comprises an apparatus and a method for reducing energy consumption by turning off power of the receiver of the base station when choosing a carrier frequency that is not supported by the handset. The receiver may be turned off for the predefined time, such as a tradeoff between saving of the energy and the providing of a sufficient delay in setup. Turning the receiver off does not affect the synchronization process, since the receiver of the handset can not be tuned to carrier frequency which is not supported by the handset.

Another technical solution is informing a handset that the base uses frequencies which the handset can support in addition to frequencies that the handset can not support and turning off the radio communications while the handset assumes that the non-supported frequencies are in use by the base unit.

It is noted that the RF activity and in particular the receiving activity during the synchronizations may be a significant contributor to the electric power consumption.

A potential technical effect is enabling base stations with reduced power consumption while enabling handsets, even old ones, to operate in the standards of communication between the handset and the base station.

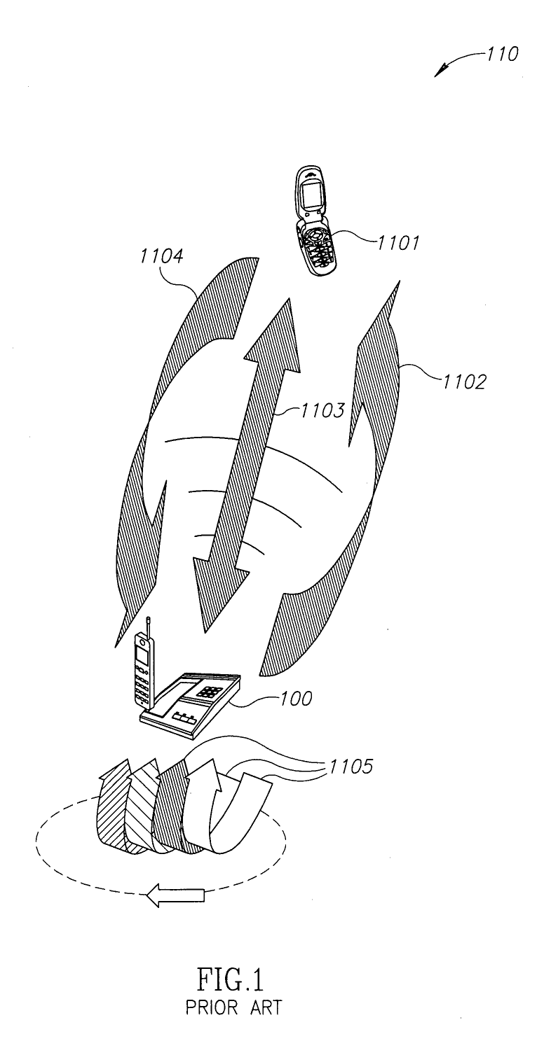

Referring now to FIG. 1 showing a schematic drawing of an environment comprising a base station and a handset. An environment 110 comprises a base station 100 and a handset 1101. During the synchronization process, the base station receiver (not shown) is periodically tuned to a next carrier frequency from the base station list of available carrier frequency 1105. When a match between the carrier frequency of the base station 100 and the handset 1101 is found, the base station answers the setup request 1103. When the synchronization process is completed, the messages 1102 from the bases station 100 to the handset 1101 and the messages 1104 from the handset 1101 the base station 100 are sent through the carrier frequency that was chosen in the setup process.

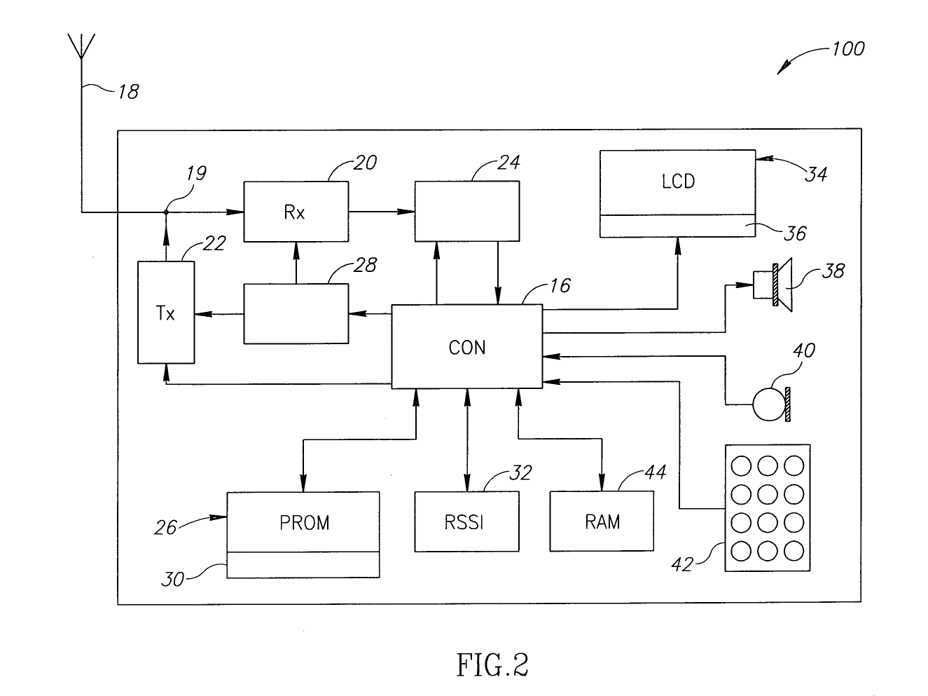

FIG. 2 shows a block diagram of a base station configured for reducing energy consumption in a base station of a cordless telephone, in accordance with some exemplary embodiments of the disclosed subject matter.

An antenna 18 is coupled to a junction 19 which is connected on the one hand to a receiver 20 and on the other hand to a transmitter 22. The receiver 20 may receive messages from the handset (not shown) and the transmitter 22 may transmit messages to the handset. A decoder 24 is connected between an output of the receiver 20 and an input to a controller 16 (CON) which controls the operation of the base station 100 in accordance with a pre-stored program in a PROM 26. A frequency synthesizer 28 is coupled to the receiver 20 and the transmitter 22, the frequency of the frequency synthesizer 28 is switchable in accordance with data supplied by the controller 16. The data may be supplied according to the base station list of available carrier frequencies (not shown).

The data, which is stored in an area 30 of the PROM 26, may take any suitable form, for example frequencies or data relating to the various divider ratios which enable the frequency synthesizer to hop through the frequencies in either the required sequence, or in accordance with an algorithm to enable the base station 100 to synchronize with the phase of the transmitted hopping sequence as received at the antenna 18. The algorithm may be a nominally random algorithm, such as an algorithm based on received signal strength measurements (RSSI) stored in a store 32 or an algorithm based on other information such as channel quality, for example, error rate information.

The controller 16 is configured for disconnecting an electric power of the receiver of the base station, if the receiver is turned on and if the next carrier frequency is a carrier frequency that is not supported by the handset. The controller 16 is configured for connecting an electric power to the receiver of the base station if the receiver is turned off and if the next carrier frequency is a carrier frequency that is supported by the handset.

In some embodiments, the disconnecting of power is lasts for a predefined time, such as a tradeoff between saving of power consumption and providing of a sufficient delay for setup, where, optionally, the predefined time sufficient for allowing subsequent listening to the handset through a carrier frequency.

In some embodiments, the power reduction can be achieved by informing the cordless handset that the base station uses frequencies which the handset can support in addition to frequencies that the handset can not support, and turning off the radio while the handset assumes that the non supported frequencies are in use by the base unit.

In some embodiments, when the base radio is off for the predefined duration of listening to the unsupported frequencies, the controller and a signal processing units in the receiver and/or other parts of the base station, are placed into low power mode to further lower the power consumption.

It is noted that, in some embodiments, turning power off comprises setting and/or changing the receiver and/or the base station to a non-active low power consumption state, optionally akin to sleep mode.

For the sake of completeness, without limiting, the base station 100 may further include an LCD panel 34 with a driver 36, a loudspeaker 38, a microphone 40, a keypad 42, and a message memory or RAM 44, all connected to the CON 16.

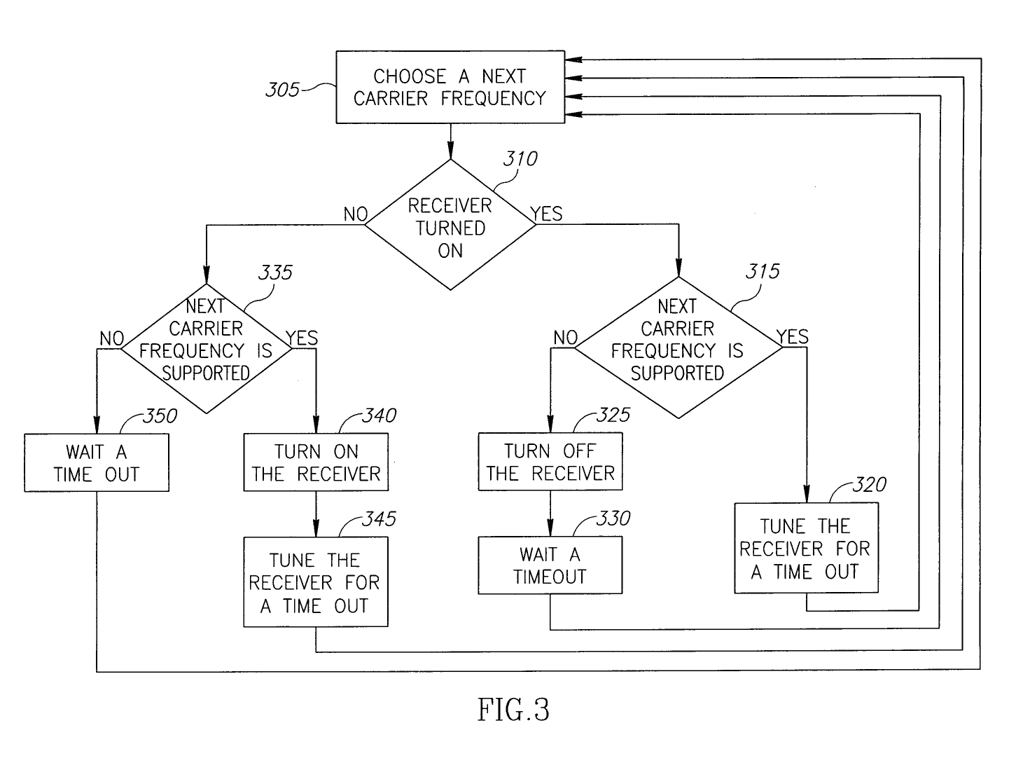

FIG. 3 shows a flowchart diagram of a method for synchronizing between a telephone and a handset while reducing energy consumption in a base station, in accordance with some exemplary embodiments of the disclosed subject matter.

At 305, the next carrier frequency may be chosen from the base station list of available carrier frequencies for tuning the receiver of the base station to the chosen frequency for making an attempt to synchronize with the handset.

At 310, the status of the receiver may be checked. Steps 315, 320, 325 and 330 may be performed if the receiver of the base station is turned on. In such a case, the receiver may be turned off if the next carrier frequency is not supported by the handset, thereby saving power.

At 315, a check may be done for finding out if the next carrier frequency that was chosen at 305 is supported by the handset. If the next carrier frequency is supported by the handset then, at 320, the receiver may be tuned to the next carrier frequency for a timeout for attempting to synchronize with the handset through the next carrier frequency. If the next carrier frequency that was chosen at 305 is not supported by the handset, the receiver may be turned off at 325, thereby saving power, and at 330 the base station may wait a timeout before choosing a next carrier frequency. Waiting a timeout while the receiver is turned off may save power consumption.

Steps 335, 340, 345 and 350 may be performed if the receiver of the base station is turned off. In such a case, the receiver may be turned back on if the next carrier frequency is supported by the handset.

At 335, a check may be done for finding out if the next carrier frequency that was chosen at 305 is supported by the handset. If the next carrier frequency is supported by the handset then, at 340, the receiver may be turned on and at 345, the receiver may be tuned to the next carrier frequency for a timeout for attempting to synchronize with the handset through the next carrier frequency. If the next carrier frequency that was chosen at 305 is not supported by the handset, then at 350, the handset may wait another timeout while the receiver is turned off, before checking the next available frequency.

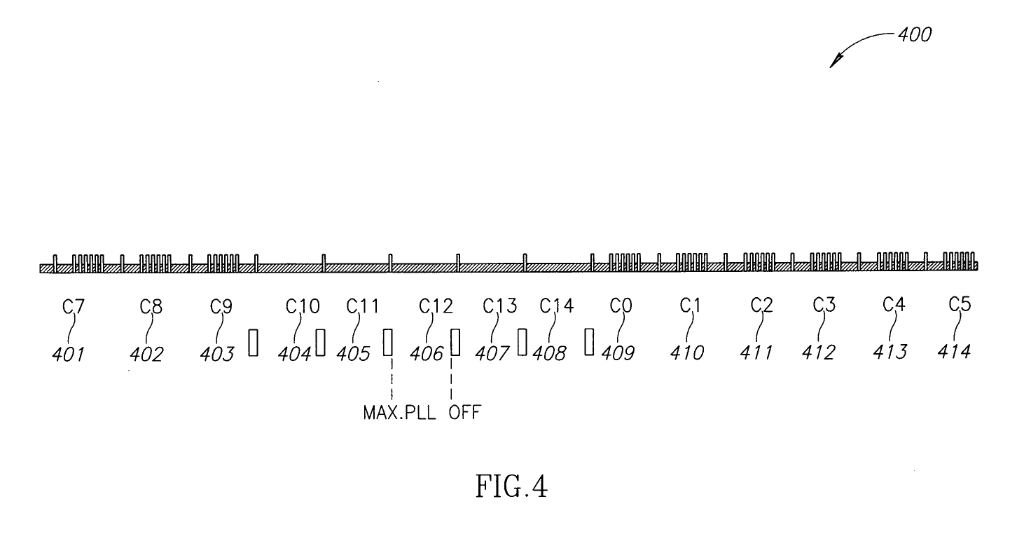

FIG. 4 shows an exemplary diagram of an exemplary time axis during which the chosen carrier frequency is changed, in accordance with some exemplary embodiments of the disclosed subject matter. Time axis 400 reflects the timely changes in the status of the receiver of the base station which are based on the base station list of available carrier frequencies. The receiver may be turned off when the next carrier frequency in the base station list of available carrier frequencies is not supported by the handset. The receiver may be turned on when it is turned off and the next carrier frequency in the base station list of available carrier frequencies is supported by the handset. Time axis 400 comprises timeframes 401, 402 and 403 during which the base station controller tries to synchronize with the handset with the corresponding carrier frequencies C7, C8 and C9, followed by time frames 404, 405, 406, 407 and 408 during which the receiver of the base station is turned off in order to save energy. Turning the receiver off is done since the carrier frequencies C10, C11, C12, C13 and C14 that are chosen in such time frames are not supported by the handset and thus, there is no need to tune the receiver to these frequencies. Time frame 408 is followed by time frames 409, 410, 411, 412, 413 and 414 during which the receiver is turned on for enabling the base station controller to try to synchronize with the handset with the corresponding carrier frequencies C1, C2, C3, C4 and C5.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of program code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the disclosed subject matter may be embodied as a system, method or computer program product. Accordingly, the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier frequency wave. The computer usable program code may be transmitted using any appropriate medium, including but not limited to wireless, wireline, optical fiber cable, RF, and the like. Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method for reducing power consumption in a base station of a cordless handset, the method comprising: powering a receiver of the base station for a carrier frequency supported by the base station and the cordless handset; and disconnecting power to a receiver of the base station for a carrier frequency that is supported by the base station and is not supported by the cordless handset.

2. The method according to claim 1, wherein the disconnecting power is for a predefined time.

3. The method according to claim 2, wherein the predefined time is sufficient for allowing subsequent listening by the base station to the cordless handset through a carrier frequency supported by the cordless handset.

4. The method according to claim 1 comprising informing the cordless handset that the base station uses carrier frequencies which the cordless handset can support in addition to carrier frequencies that the cordless handset can not support.

5. The method according to claim 1, comprising setting parts of the base station to lower power for the carrier frequency that is supported by the base station and is not supported by the cordless handset.

6. An apparatus for reducing power consumption in a base station of a cordless handset, the apparatus comprising: a base station supporting a plurality of carrier frequencies and having a receiver configured to receive a transmission from the cordless handset supporting a subset of the plurality of carrier frequencies, wherein the base station further comprises a controller that is configured for turning off power to the receiver for carrier frequencies that are of the plurality of carrier frequencies and are not supported by the cordless handset and for connecting the receiver to the power for a carrier frequency that belongs to the subset of the plurality of carrier frequencies.

7. The apparatus according to claim 6, further adapted to turn off wireless communication of the base station.

8. The apparatus according to claim 6, that is arranged to inform the cordless handset that the base station uses carrier frequencies which the cordless handset can support in addition to carrier frequencies that the cordless handset can not support.

9. The apparatus according to claim 6 that is arranged to set parts of the base station to lower power for carrier frequencies that belong to the plurality of carrier frequencies and are not supported by the cordless handset.

10. The method according to claim 4 further comprising turning off wireless communications for the carrier frequencies that the cordless handset can not support thereby allowing the cordless handset to assume that the carrier frequencies that are not supported by the cordless handset are in use by the base station.

11. The method according to claim 1 wherein the powering and the disconnecting are preceded by: selecting a next carrier frequency to be used by the base station;
determining whether the next carrier frequency is supported by both the base station and the handset; and executing one of the powering and the disconnecting in response to the determination.

12. The method according to claim 11 comprising periodically selecting the next carrier frequency out of a plurality of carrier frequencies supported by the base station.

13. The method according to claim 1 comprising powering the receiver of the base station for all carrier frequencies supported by the base station and the cordless handset; and disconnecting power to the receiver of the base station for all carrier frequencies that are supported by the base station and are not supported by the cordless handset.

14. The method according to claim 2 comprising informing the cordless handset that the base station uses carrier frequencies which the cordless handset can support in addition to carrier frequencies that the cordless handset does not support.

15. The apparatus according to claim 8 further arranged to turn off wireless communications for the carrier frequencies that are of the plurality of carrier frequencies and are not supported by the cordless handset thereby allowing the cordless handset to assume that the carrier frequencies that are not supported by the cordless handset are in use by the base station.

16. The apparatus according to claim 6 further arranged to select a next carrier frequency to be used by the base station; provide a determination whether the next carrier frequency is supported by both the base station and the handset; and wherein the controller is arranged to either turning off power to the receiver or connect the receiver to the power in response to the determination.

17. The apparatus according to claim 7 arranged to inform the cordless handset that the base station uses carrier frequencies which the cordless handset can support in addition to carrier frequencies that the cordless handset does not support.
